(19) United States
(12) Patent Application Publication
(10) Pub. No.: US 2025/0105265 A1
(43) Pub. Date: Mar. 27, 2025

(54) NEGATIVE ACTIVE MATERIAL, SECONDARY BATTERY AND ELECTRONIC DEVICE

(71) Applicant: Ningde Amperex Technology Limited, Ningde (CN)

(72) Inventors: Xin LI, Ningde (CN); Yisong SU, Ningde (CN); Yuansen XIE, Ningde (CN)

(73) Assignee: Ningde Amperex Technology Limited, Ningde (CN)

(21) Appl. No.: 18/894,061

(22) Filed: Sep. 24, 2024

(30) Foreign Application Priority Data
Sep. 25, 2023 (CN) 202311242973.1

(51) Int. Cl. H01M 4/36; H01M 4/02; H01M 4/38; H01M 4/60; H01M 4/62; H01M 10/0525; H01M 10/0569

(52) U.S. Cl. CPC H01M 4/366; H01M 4/386; H01M 4/604; H01M 4/625; H01M 10/0525; H01M 10/0569; H01M 2004/021; H01M 2004/027; H01M 2300/004; H01M 2300/0042

(57) ABSTRACT

A negative active material includes a silicon-based composite material. The silicon-based composite material includes a silicon substrate, a conductive agent and a polymer. The conductive agent and the polymer are disposed on at least a portion of a surface of the silicon substrate. The silicon-based composite material has a powder conductivity from 0.03 S/cm to 0.1 S/cm.

### CROSS-REFERENCE TO RELATED APPLICATION

The present application claims priority to Chinese Patent application No. CN 202311242973.1 filed in the China National Intellectual Property Administration on Sep. 25, 2023, the entire content of which is hereby incorporated by reference.

### TECHNICAL FIELD

This application relates to the field of electrochemical technology, and in particular to a negative active material, a secondary battery and an electronic device.

### BACKGROUND

Secondary batteries, such as lithium-ion batteries, have characteristics such as high operating voltage, high energy density, long cycle life, and wide operating temperature range. These excellent characteristics have enabled the lithium-ion batteries to realize a wide range of applications in three major fields of consumer electronics, power batteries and energy storage.

Silicon materials have a theoretical gram capacity of up to 4200 mAh/g, which have a broad application prospect in the lithium-ion batteries. However, the volume expansion of silicon materials ranges from 120% to 300% with the embedding and detaching of lithium ions during charge/discharge cycling, and the volume expansion of silicon materials releases stresses that result in the increase of pores of a negative electrode plate, resulting in the expansion of the volume of the negative electrode plate, and thus affecting the expansion performance of the lithium-ion batteries.

### SUMMARY

An objective of this application is to provide a negative active material, a secondary battery and an electronic device to improve the expansion performance of the secondary battery. The specific technical solutions are as follows:

A first aspect of this application provides a negative active material including a silicon-based composite material. The silicon-based composite material includes a silicon substrate, a conductive agent and a polymer, the conductive agent and the polymer are disposed on at least a portion of a surface of the silicon substrate, a peak intensity of peak D in a Raman spectrum of the silicon-based composite material with a shift of 1255 cm⁻¹ to 1400 cm⁻¹ is Ip, and a peak intensity of peak G in the Raman spectrum of the silicon-based composite material with a shift of 1550 cm⁻¹ to 1625 cm⁻¹ is I_{G}, a ratio of Ip to I_{G} is A, and 0.15≤A≤1.15. The silicon-based composite material has a stretching vibration peak of a carbon-oxygen double bond at 1450+20 cm⁻¹ in an infrared spectrum, and a powder conductivity of the silicon-based composite material is from 0.03 S/cm to 0.1 S/cm. The negative active material includes a silicon-based composite material, the silicon-based composite material includes the conductive agent and the polymer which are disposed on at least a portion of a surface of the silicon substrate, and by adjusting the value of A and the powder conductivity of the silicon-based composite material within the ranges of this application, the negative active material can be made to have a complete conductive network while being able to release the stresses generated by the silicon expansion. Applying the negative active material having the above characteristics to the secondary battery is conducive to reducing the amount of increase in the porosity of the negative electrode plate due to the stresses released from the silicon expansion, alleviating the expansion of the silicon-based negative electrode plate, and thereby improving the cycling performance and the expansion performance of the secondary battery.

In some implementation solutions of this application, Dv50/Dv10 of the silicon-based composite material satisfies 1.25≤Dv50/Dv10≤7, and Dv50 of the silicon-based composite material is from 5 μm to 12 μm. By adjusting the values of the Dv50/Dv10 and Dv50 of the silicon-based composite material within the above ranges, it is conducive to improving the porosity of the negative electrode plate, releasing the stresses generated by the silicon expansion, and alleviating the expansion of the silicon-based negative electrode plate, thereby improving the cycling performance and the expansion performance of the secondary battery.

In some implementation solutions of this application, Dv10 of the silicon-based composite material is from 1.7 μm to 4 μm. By adjusting the value of the Dv10 of the silicon-based composite material within the above range, it is conducive to improving the porosity of the negative electrode plate, releasing the stresses generated by the silicon expansion, and alleviating the expansion of the silicon-based negative electrode plate, thereby improving the cycling performance and the expansion performance of the secondary battery.

In some implementation solutions of this application, the negative active material satisfies at least one of the following characteristics: (1) 0.35≤A≤0.85; (2) the powder conductivity of the silicon-based composite material is from 0.04 S/cm to 0.08 S/cm; or (3) the Dv50/Dv10 of the silicon-based composite material satisfies 2≤Dv50/Dv10≤3.5. The negative active material having the above characteristics has better electrical conductivity. Appling the negative active material to a secondary battery can alleviate the expansion of the silicon-based negative electrode plate, thereby improving the cycling performance and the expansion performance of the secondary battery.

In some implementation solutions of this application, the conductive agent is in a form of threads, and the polymer is in a form of particles. The negative active material satisfies at least one of the following characteristics: (1) a diameter of a circumscribed circle of the particles of the polymer is X nm, and 10≤X≤200; (2) an average diameter of the conductive agent is Y nm, and 0.5≤Y≤20; an average length of the conductive agent is Z μm, and 0.5≤Z≤11; or (3) a diameter of a circumscribed circle of the particles of the polymer is X nm, an average diameter of the conductive agent is Y nm, and 0.5≤X/Y≤400. The negative active material having the above characteristics has better electrical conductivity, which allows for a better utilization of the conductive agent and the polymer, and releases stresses generated by the silicon expansion. Applying the negative active material to a secondary battery can improve the cycling performance and the expansion performance of the secondary battery.

In some implementation solutions of this application, the conductive agent is in a form of threads, and the polymer is in a form of particles. The negative active material satisfies at least one of the following characteristics: (1) a diameter of a circumscribed circle of the particles of the polymer is X nm, and 20≤X≤140; (2) an average diameter of the conductive agent is Y nm, and 0.5≤Y≤14; an average length of the conductive agent is Z μm, and 1≤Z≤8; or (3) a diameter of a circumscribed circle of the particles of the polymer is X nm, an average diameter of the conductive agent is Y nm, and 0.7≤X/Y≤280. The negative active material having the above characteristics has better electrical conductivity, which allows for a better utilization of the conductive agent and the polymer, and releases stresses generated by the silicon expansion. Applying the negative active material to a secondary battery can further improve the cycling performance and the expansion performance of the secondary battery.

In some implementation solutions of this application, the silicon substrate includes a silicon element and a carbon element; the conductive agent includes a carbon nanotube; and the polymer includes at least one selected from the group consisting of polyacrylate, polyimide, polyamide, polyamideimide, polyurethane, sodium carboxymethyl cellulose, potassium carboxymethyl cellulose, sodium hydroxymethyl cellulose, or potassium hydroxymethyl cellulose. By selecting the silicon substrate material, the conductive agent, and the polymer within the above ranges, the negative active material has a complete conductive network while being able to release the stresses generated by the silicon expansion. By applying the negative active material having the above characteristics to the secondary battery, it is possible to reduce the amount of increase in the porosity of the negative electrode plate due to the stresses released from the silicon expansion and alleviate the expansion of the silicon-based negative electrode plate, thereby improving the cycling performance and the expansion performance of the secondary battery.

A second aspect of this application provides a secondary battery, including a positive electrode plate, a negative electrode plate and an electrolyte solution. The negative electrode plate includes a negative active material provided in the first aspect of this application. The secondary battery includes the above-described negative active material, such that the secondary battery has excellent cycling performance and expansion performance.

In some implementation solutions of this application, a compaction density of the negative electrode plate is from 0.9 g/cm³ to 1.9 g/cm³. When the compaction density of the negative electrode plate is adjusted within the above range, the negative electrode plate has excellent structural stability, which can alleviate the expansion of the silicon-based negative electrode plate, thereby improving the cycling performance and the expansion performance of the secondary battery.

In some implementation solutions of this application, the electrolyte solution includes fluoroethylene carbonate, based on a mass of the electrolyte solution, a mass percentage of the fluoroethylene carbonate is C %, and 0.01≤A/C≤0.23. The electrolyte solution includes the fluoroethylene carbonate, which is conducive to forming a stable solid electrolytic interfacial film of a suitable thickness on the surface of the negative electrode plate, improving the stability of the negative electrode plate, and further alleviating the stresses generated by the silicon substrate, and alleviating the expansion of the silicon-based negative electrode plate, thereby improving the cycling performance and the expansion performance of the secondary battery.

In some implementation solutions of this application, 5≤C≤15. By adjusting the value of C within the above range, it is conductive to forming a stable solid electrolytic interfacial film of a suitable thickness on the surface of the negative electrode plate, improving the stability of the negative electrode plate, and alleviating the expansion of the silicon-based negative electrode plate, thereby improving the cycling performance and the expansion performance of the secondary battery.

A third aspect of this application provides an electronic device, including a secondary battery provided in the second aspect of this application. The secondary battery provided in the second aspect of this application has excellent cycling performance and expansion performance, and therefore the electronic device of this application has a long service life.

This application has the beneficial effects:

This application provides the negative active material, the secondary battery and the electronic device. The negative active material includes the silicon-based composite material. The silicon-based composite material includes the silicon substrate, the conductive agent and the polymer, and the conductive agent and the polymer is disposed on at least a portion of the surface of the silicon substrate. The peak intensity of the peak D in the Raman spectrum of the silicon-based composite material with a shift of 1255 cm⁻¹ to 1400 cm⁻¹ is I_{D}, the peak intensity of the peak G in the Raman spectrum of the negative active material with a shift of 1550 cm⁻¹ to 1625 cm⁻¹ is I_{G}, the ratio of I_{D} to I_{G} is A, and 0.15≤A≤1.15. The silicon-based composite material has the stretching vibration peak of the carbon-oxygen double bond at 1450+20 cm⁻¹ in the infrared spectrum, and the powder conductivity of the silicon-based composite material is from 0.03 S/cm to 0.1 S/cm. The negative active material having the above characteristics is applied to the secondary battery, and by adjusting the value of A and the powder conductivity of the silicon-based composite material within the ranges of this application, the negative active material can be made to have a complete conductive network while releasing the stresses generated by the silicon expansion, and reducing the amount of increase in the porosity of the negative electrode plate due to the stresses released from the silicon expansion, thereby alleviating the expansion of the silicon-based negative electrode plate, and improving the cycling performance and the expansion performance of the secondary battery.

Of course, implementing any product or method of this application is not necessary to achieve all the above-mentioned advantages simultaneously.

### BRIEF DESCRIPTION OF DRAWINGS

In order to more clearly illustrate technical solutions in embodiments of this application or prior art, accompanying drawings to be referred for descriptions of the embodiments or the prior art will be briefly described below. Apparently, the accompanying drawings in the following descriptions are merely some embodiments of this application, and a person of ordinary skill in the art may further obtain other embodiments based on these accompanying drawings.

FIG. 1 is a scanning electron micrograph of a silicon-based composite material of Embodiment 1-1.

FIG. 2 is a scanning electron micrograph of a silicon substrate of Comparative Embodiment 1.

FIG. 3 is a Raman spectrum of the silicon-based composite material of Embodiment 1-1.

FIG. 4 is a Raman spectrum of the silicon substrate of Comparative Embodiment 1.

FIG. 5 is an infrared spectrum of the silicon-based composite material of Embodiment 1-1.

FIG. 6 is an infrared spectrum of the silicon substrate of Comparative Embodiment 1.

### DETAILED DESCRIPTION

The technical solutions in embodiments of this application are clearly and completely described with reference to the accompanying drawings in the embodiments of this application. Apparently, the described embodiments are some rather than all of the embodiments of this application. Based on the embodiments in this application, all other embodiments derived by a person of ordinary skill in the art shall fall within the scope of protection of this application.

It is hereby noted that in the specific embodiments of this application, this application is explained by an example using a lithium-ion battery as a secondary battery, but the secondary battery of this application is not limited to the lithium-ion battery.

A first aspect of this application provides a negative active material including a silicon-based composite material, the silicon-based composite material includes a silicon substrate, a conductive agent and a polymer, the conductive agent and the polymer are disposed on at least a portion of a surface of the silicon substrate, the peak intensity of peak D in the Raman spectrum of the silicon-based composite material with a shift of 1255 cm⁻¹ to 1400 cm⁻¹ is I_{D}, the peak intensity of peak G in the Raman spectrum of the silicon-based composite material composite with a shift of 1550 cm⁻¹ to 1625 cm⁻¹ is I_{G}, a ratio of I_{D} to I_{G} is A, and 0.15≤A≤1.15, and preferably 0.35≤A≤0.85. For example, the value of A may be 0.15, 0.30, 0.45, 0.5, 0.75, 0.90, 1.00, 1.15 or a value falling within a range consisting of any two of these values. The silicon-based composite material has a stretching vibration peak of a carbon-oxygen double bond at 1450+20 cm⁻¹ in an infrared spectrum, and the powder conductivity of the silicon-based composite material is from 0.03 S/cm to 0.1 S/cm, preferably from 0.04 S/cm to 0.08 S/cm. For example, the powder conductivity of the silicon-based composite material may be 0.03 S/cm, 0.04 S/cm, 0.05 S/cm, 0.06 S/cm, 0.07 S/cm, 0.08 S/cm, 0.09 S/cm, 0.1 S/cm or a value falling within a range consisting of any two of these values.

The negative active material provided in this application includes the silicon-based composite material, the silicon-based composite material includes the conductive agent and the polymer which are disposed on at least a portion of the surface of the silicon substrate, which can provide a complete conductive network for the negative active material while enabling the silicon substrate to release stresses generated by silicon expansion through the breakage of a chemical bond as well as a hydrogen bond of the polymer in the expansion process, which is conducive to reducing the amount of increase in the porosity of the negative electrode plate due to the stresses released from the silicon expansion, and alleviating the expansion of the silicon-based negative electrode plate, so that the cycling performance and expansion performance of the secondary battery can be improved. The silicon-based composite material includes the conductive agent and the polymer, and the value of A is adjusted to be within the range of this application, which is conducive to exerting a synergistic effect of the conductive agent and the polymer, which can provide a complete conductive network for the negative active material while utilizing the breakage of the chemical bonding as well as the hydrogen bonding of the polymer to release the stresses generated by the silicon expansion and thus alleviating the expansion of the silicon-based negative electrode plate. When the silicon-based composite material does not have the above-described stretching vibration peak of the carbon-oxygen double bond and the powder conductivity is too large, the stresses generated by the silicon expansion accumulates, and the silicon expansion is intensified, leading to the rupture of a bonding network among the negative active materials, which affects the capacity of the negative active materials, and thus affects the expansion performance and the cycling performance of the secondary battery. When the silicon-based composite material does not have the above-described stretching vibration peak of the carbon-oxygen double bond and the powder conductivity is too small, a complete conductive network cannot be formed in the negative active material, which is not conducive to the transmission of ions, and affects the cycling performance of the secondary battery. The silicon-based composite material has the above-described stretching vibration peak of the carbon-oxygen double bond, and by adjusting the value of A and the powder conductivity of the silicon-based composite material within the ranges of this application, the negative active material can be made to have a complete conductive network while being able to release the stresses generated by the silicon expansion. Applying the negative active material having the above characteristics to the secondary battery is conducive to reducing the amount of increase in the porosity of the negative electrode plate due to the stresses released from the silicon expansion, and alleviating the expansion of the silicon-based negative electrode plate, thereby improving the cycling performance and the expansion performance of the secondary battery.

In some implementation solutions of this application, Dv50/Dv10 of the silicon-based composite material satisfies 1.25≤Dv50/Dv10≤7, preferably 2≤Dv50/Dv10≤3.5, and Dv50 of the silicon-based composite material is from 5 μm to 12 μm. For example, the value of Dv50/Dv10 may be 1.25, 1.5, 2, 2.5, 3, 3.5, 4, 5, 6, 7 or a value falling within a range consisting of any two of these values. The Dv50 of the silicon-based composite material may be 5 μm, 6 μm, 7 μm, 8 μm, 9 μm, 10 μm, 11 μm, 12 μm or a value falling within a range consisting of any two of these values. By adjusting the values of Dv50/Dv10 and Dv50 of the silicon-based composite material within the above ranges, it is conducive to improving the porosity of the negative electrode plate, releasing the stresses generated by the silicon expansion, and alleviating the expansion of the silicon-based negative electrode plate, thereby improving the cycling performance and the expansion performance of the secondary battery. In this application, “Dv50” refers to a particle diameter of particles when the cumulative volume percent reaches 50%, from the small-diameter side, in a volume-based particle size distribution curve of the material. “Dv10” refers to a particle diameter of particles when the cumulative volume percent reaches 10%, from the small-diameter side, in the volume-based particle size distribution curve of the material.

In some implementation solutions of this application, Dv10 of the silicon-based composite material is from 1.7 μm to 4 μm. For example, the Dv10 of the silicon-based composite material may be 1.7 μm, 2 μm, 2.5 μm, 3 μm, 3.5 μm, 3.7 μm, 4 μm or a value falling within a range consisting of any two of these values. By adjusting the value of Dv10 of the silicon-based composite material within the above range, it is conducive to improving the porosity of the negative electrode plate, releasing the stresses generated by the silicon expansion, and alleviating the expansion of the silicon-based negative electrode plate, thereby improving the cycling performance and the expansion performance of the secondary battery.

In some implementation solutions of this application, the conductive agent is in a form of threads and the polymer is in a form of particles. The conductive agent and the polymer have the above characteristics, which enables the negative active material to have both a complete conductive network and an excellent structural stability, which is conducive to releasing the stresses generated by silicon expansion, and alleviating the expansion of the silicon-based negative electrode plate, thereby improving the cycling performance and the expansion performance of the secondary battery.

In some implementation solutions of this application, a diameter of a circumscribed circle of the particles of the polymer is X nm, 10≤X≤200, preferably 20≤X≤140. For example, the value of X may be 10, 20, 30, 50, 70, 90, 100, 120, 140, 150, 170, 180, 200 or a value falling within a range consisting of any two of these values. By adjusting the value of X within the above range, it is conductive to improving the structural stability of the negative active material, and utilizing the polymer to adhere the thread-like conductive agent to a surface of the silicon substrate, thereby enabling the negative active material to have a complete conductive network, alleviating the expansion of the silicon-based negative electrode plate, and thus improving the cycling performance and the expansion performance of the secondary battery.

In some implementation solutions of this application, an average diameter of the conductive agent is Y nm, 0.5≤Y≤20, preferably 0.5≤Y≤14. An average length of the conductive agent is Z μm, 0.5≤Z≤11, preferably 1≤Z<8. For example, the value of Y may be 0.5, 1, 3, 5, 7, 9, 10, 12, 14, 15, 18, 20 or a value falling within a range consisting of any two of these values, and the value of Z may be 0.5, 1, 2, 3, 5, 8, 10, 11 or a value falling within a range consisting of any two of these values. By adjusting the values of Y and Z within the above ranges, it is possible to enable the negative active material to have an excellent electronic conductivity, and alleviate the expansion of the silicon-based negative electrode plate, thereby improving the cycling performance and the expansion performance of the secondary battery.

In some implementation solutions of this application, the diameter of a circumscribed circle of the particles of the polymer is X nm, the average diameter of the conductive agent is Y nm, and 0.5≤X/Y≤400, preferably 0.7≤X/Y≤280. For example, the value of X/Y may be 0.5, 0.7, 2, 10, 30, 50, 75, 100, 150, 200, 250, 280, 300, 350, 400 or a value falling within a range consisting of any two of these values. The negative active material having the above characteristics utilizes the conductive agent to provide a complete conductive network for the negative active material, and at the same time utilizes the polymer to adhere the conductive agent to a surface of the silicon substrate, so as to improve the stability of the conductive network, and further play the role of alleviating the stresses generated by the expansion of the silicon substrate through the breakage of the chemical bonding as well as the hydrogen bonding of the polymer. Furthermore, the negative active material has better electrical conductivity. Applying the negative active material to a secondary battery is conducive to further alleviating the expansion of the silicon-based negative electrode plate, thereby improving the cycling performance and the expansion performance of the secondary battery.

In this application, the conductive agent is in the form of threads and the polymer is in the form of particles. The characteristics in the above implementation solutions: the diameter X of the circumscribed circle of the particles of the polymer, the average diameter Y and the average length Z of the conductive agent, the value of X/Y, and the like may be combined in any combination, and the negative active material satisfies at least one of the above characteristics.

In some implementation solutions of this application, a mass ratio of the silicon substrate to the conductive agent is 100:0.004 to 100:0.032. For example, the mass ratio of the silicon substrate to the conductive agent may be 100:0.004, 100:0.008, 100:0.01, 100:0.015, 100:0.018, 100:0.02, 100:0.022, 100:0.025, 100:0.03, 100:0.032, or a value falling within a range consisting of any two of these values. In some implementation solutions of this application, a mass ratio of the silicon substrate to the polymer is from 100:0.005 to 100:8. For example, the mass ratio of the silicon substrate to the polymer may be 100:0.005, 100:0.01, 100:0.05, 100:0.5, 100:1, 100:2, 100:3, 100:5, 100:8 or a value falling within a range consisting of any two of these values. By adjusting the mass ratio of the silicon substrate to the conductive agent and the mass ratio of the silicon substrate to the polymer, it is possible to enable the negative active material to have both a complete conductive network and an excellent structural stability, which is conductive to releasing the stresses generated by the silicon expansion, and alleviating the expansion of the silicon-based negative electrode plate, thereby improving the cycling performance and the expansion performance of the secondary battery.

In some implementation solutions of this application, the silicon substrate includes a silicon element and a carbon element, and this application has no particular limitation on the mass ratio of the silicon element to the carbon element, as long as the purpose of this application can be realized. For example, the mass ratio of the silicon element to the carbon element may be (40:60) to (70:30). In some implementation solutions of this application, the silicon substrate includes a silicon-carbon material. In some implementation solutions of this application, the conductive agent includes a carbon nanotube. The carbon nanotube may include, but is not limited to, at least one of a single-walled carbon nanotube or a multi-walled carbon nanotube. In some implementation solutions of this application, the polymer includes at least one selected from the group consisting of polyacrylate, polyimide (PI), polyamide, polyamideimide, polyurethane, sodium carboxymethyl cellulose, potassium carboxymethyl cellulose, sodium hydroxymethyl cellulose, or potassium hydroxymethyl cellulose. The above-described polyacrylates include at least one selected from the group consisting of poly(methyl acrylate) (PMA), poly(ethyl acrylate), poly(n-propyl acrylate), or poly(n-butyl acrylate). This application has no particular limitation on the weight-average molecular weight of the above polymers, as long as the purpose of this application can be realized. For example, the weight-average molecular weight of the above polymers may be from 10,000 to 500,000. By selecting the silicon substrate material, the conductive agent, and the polymer within the above ranges, the negative active material has a complete conductive network while being able to release the stresses generated by the silicon expansion. By applying the negative active material having the above characteristics to the secondary battery, it is possible to reduce the amount of increase in the porosity of the negative electrode plate due to the stresses released from the silicon expansion, and alleviate the expansion of the silicon-based negative electrode plate, thereby improving the cycling performance and the expansion performance of the secondary battery.

This application has no particular limitation on the preparation method of the silicon-based composite material, as long as the purpose of this application can be realized. For example, the preparation method of the silicon-based composite material may include, but is not limited to, the following steps: (1) evenly mixing the silicon substrate and the conductive agent and then drying them to obtain a powder; and (2) evenly mixing the resulting powder with the polymer and then drying them to obtain a silicon-based composite material. This application has no particular limitation on the way of mixing, as long as the purpose of this application can be realized. For example, it can be realized by stirring at room temperature. This application has no particular limitation on the stirring time, as long as the purpose of this application can be realized. For example, the stirring time of steps (1) and (2) may each be from 10 min to 150 min. This application has no particular limitation on the drying temperature, as long as the purpose of this application can be realized. For example, the drying temperature of steps (1) and (2) may each be from 50° C. to 250° C.

Typically, the value of A can be adjusted by changing the mass ratio of the silicon substrate to the conductive agent, the mass ratio of the silicon substrate to the polymer, the stirring time of step (2), and the drying temperature of step (2). Increasing the mass ratio of the silicon substrate to the conductive agent increases the value of A. Decreasing the mass ratio of the silicon substrate to the conductive agent decreases the value of A. Increasing the mass ratio of the silicon substrate to the polymer, the value of A increases. Decreasing the mass ratio of the silicon substrate to the polymer decreases the value of A. Prolonging the stirring time of step (2) decreases the value of A. Shortening the stirring time of step (2) increases the value of A. Increasing the drying temperature of step (2) decreases the value of A. Decreasing the drying temperature of step (2) increases the value of A.

Typically, the powder conductivity of the silicon-based composite material can be adjusted by changing the mass ratio of the silicon substrate to the conductive agent, the mass ratio of the silicon substrate to the polymer, the stirring time of step (2), and the drying temperature of step (2). Increasing the mass ratio of the silicon substrate to the conductive agent decreases the powder conductivity of the silicon substrate composite material. Decreasing the mass ratio of the silicon substrate to the conductive agent increases the powder conductivity of the silicon substrate composite material. Increasing the mass ratio of the silicon substrate to the polymer increases the powder conductivity of the silicon-based composite material. Decreasing the mass ratio of the silicon substrate to the polymer decreases the powder conductivity of the silicon-based composite material. Prolonging the stirring time of step (2) decreases the powder conductivity of the silicon-based composite material. Shortening the stirring time of step (2) increases the powder conductivity of the silicon-based composite material. Increasing the drying temperature of step (2) decreases the powder conductivity of the silicon-based composite material. Decreasing the drying temperature of step (2) increases the powder conductivity of the silicon-based composite material.

Typically, Dv50 and Dv10 of the silicon-based composite material can be adjusted by changing Dv50 and Dv10 of the silicon substrate. The values of Dv50 and Dv10 of the silicon substrate increase, so the values of Dv50 and Dv10 of the silicon-based composite material increase. The values of Dv50 and Dv10 of the silicon substrate decrease, so the values of Dv50 and Dv10 of the silicon-based composite material decrease. Dv50 and Dv10 of the silicon-based composite material can also be adjusted by changing the stirring time and the drying temperature. Prolonging the stirring time decreases the values of Dv50 and Dv10 of the silicon-based composite material. Shortening the stirring time increases the values of Dv50 and Dv10 of the silicon-based composite material. Increasing the drying temperature increases the values of Dv50 and Dv10 of the silicon-based composite material. Decreasing the drying temperature decreases the values of Dv50 and Dv10 of the silicon-based composite material.

Typically, the value of the diameter X of the circumscribed circle of the particles of the polymer can be changed by selecting polymer raw materials with different weight-average molecular weights. Increasing the weight-average molecular weight of the polymer increases the value of X. Decreasing the weight-average molecular weight of the polymer decreases the value of X. Typically, the values of the average diameter Y and the average length Z of the conductive agent can be changed by selecting conductive agent raw materials with different average diameters and average lengths.

The negative active material of this application may also include a carbon material such as graphite or mesocarbon microbeads, and graphite may include, but is not limited to, at least one of artificial graphite or natural graphite or the like. In some implementation solutions, the negative active material includes a silicon-based composite material and graphite. In some implementation solutions, the negative active material includes a silicon-based composite material and mesocarbon microbeads. This application has no particular limitation on a mass ratio of the silicon-based composite material to the above-described carbon material, as long as the purpose of this application can be realized. For example, the mass ratio of the silicon-based composite material to the above-described carbon material may be (10 to 30):(68 to 88).

A second aspect of this application provides a secondary battery, including a positive electrode plate, a negative electrode plate, and an electrolyte solution. The negative electrode plate includes a negative current collector and a negative active material layer disposed on at least one surface of the negative current collector, and the negative active material layer includes the negative active material provided in the first aspect of this application. The secondary battery includes the above-described negative active material, the negative electrode plate has an excellent electrical conductivity, and can alleviate the expansion of the silicon-based negative electrode plate, and the secondary battery has excellent cycling performance and expansion performance.

In some implementation solutions of this application, the negative electrode plate has a compaction density from 0.9 g/cm³ to 1.9 g/cm³. For example, the negative electrode plate may have a compaction density of 0.9 g/cm³, 1.0 g/cm³, 1.1 g/cm³, 1.2 g/cm³, 1.3 g/cm³, 1.4 g/cm³, 1.5 g/cm³, 1.6 g/cm³, 1.7 g/cm³, 1.8 g/cm³, 1.9 g/cm³ or a value falling within a range consisting of any two of these values. By adjusting the compaction density of the negative electrode plate within the above range, the negative electrode plate has a higher compaction density while having a higher porosity, which is conducive to further alleviating the expansion of the silicon-based negative electrode plate, thereby improving the cycling performance and the expansion performance of the secondary battery.

Typically, the compaction density of the negative electrode plate can be adjusted by changing the cold pressing pressure. Increasing the cold pressing pressure increases the compaction density of the negative electrode plate, and decreasing the cold pressing pressure decreases the compaction density of the negative electrode plate.

In some implementation solutions of this application, the electrolyte solution includes fluoroethylene carbonate, based on a mass of the electrolyte solution, a mass percentage of the fluoroethylene carbonate is C %, and 0.01≤A/C≤0.23. For example, the value of A/C may be 0.01, 0.015, 0.02, 0.03, 0.04, 0.05, 0.07, 0.08, 0.09, 0.10, 0.13, 0.15, 0.18, 0.20, 0.23 or a value falling within a range consisting of any two of these values. The electrolyte solution includes the fluoroethylene carbonate, which is conductive to forming a stable solid electrolytic interfacial film of a suitable thickness on the surface of the negative electrode plate and improving the stability of the negative electrode plate, and after the negative electrode plate is infiltrated with the electrolyte solution, the fluoroethylene carbonate can also synergistically act with the above-described negative active material, which is more conducive to exerting the effect of relieving the stresses generated by the expansion of the silicon substrate through breakage of the chemical bonding as well as the hydrogen bonding of the polymer, thereby relieving the expansion of the silicon-based negative electrode plate, and thus improving the cycling performance and the expansion performance of the secondary battery.

In some implementation solutions of this application, 5≤C≤15. For example, the value of C may be 5, 7, 8, 9, 10, 11, 12, 13, 15 or a value falling within a range consisting of any two of these values. By adjusting the value of C within the above range, it is conductive to forming a stable solid electrolytic interfacial film of a suitable thickness on the surface of the negative electrode plate, improving the stability of the negative electrode plate, and also alleviating the expansion of the silicon-based negative electrode plate, thereby improving the cycling performance and the expansion performance of the secondary battery.

This application has no particular limitation on the negative current collector, as long as the purpose of this application can be realized. For example, the negative current collector may include copper foil, aluminum foil, nickel foil, stainless steel foil, titanium foil, nickel foam, copper foam, or a polymer substrate coated with a conductive metal, or the like. Here, the conductive metal includes, but is not limited to, copper, nickel, or titanium, and the material of the polymer substrate includes, but is not limited to, at least one selected from the group consisting of polyethylene, polypropylene, ethylene-propylene copolymer, poly(ethyleneglycol p-phthalate), polyethylene naphthalate, or poly(p-phenylene terephthalamide). This application has no particular limitation on the thicknesses of the negative current collector and the negative active material layer, as long as the purpose of this application can be realized. For example, the thickness of the negative current collector is from 4 μm to 12 μm, and the thickness of the single-sided negative active material layer is from 30 μm to 160 μm. In this application, the negative active material layer may be disposed on a single surface in the thickness direction of the negative current collector, or may be disposed on two surfaces in the thickness direction of the negative current collector. It is hereby noted that the “surface” herein may be the entire area of the negative current collector or a part of an area of the negative current collector, and this application has no particular limitation as long as the purpose of this application can be realized. The negative active material layer in this application may also include a negative electrode binder and a negative electrode dispersant. This application has no particular limitation on the types of the negative electrode binder and the negative electrode dispersant, as long as the purpose of this application can be realized. For example, the negative electrode binder may include, but is not limited to, at least one selected from the group consisting of polyacrylate, polyimide, polyamide, polyamideimide, polyvinylidene fluoride, styrene-butadiene rubber, sodium alginate, polyvinyl alcohol, polytetrafluoroethylene, polyacrylonitrile, sodium carboxymethyl cellulose, potassium carboxymethyl cellulose, sodium hydroxymethyl cellulose, or potassium hydroxymethyl cellulose. The negative electrode dispersant may include, but is not limited to, carboxymethylcellulose or sodium carboxymethyl cellulose.

This application has no particular limitation on the positive electrode plate, as long as the purpose of this application can be realized. For example, the positive electrode plate may include a positive current collector and a positive active material layer provided on at least one surface of the positive current collector. This application has no particular limitation on the positive current collector, as long as the purpose of this application can be realized. For example, the positive current collector may include metal foil or a composite current collector or the like. For example, the metal foil may be aluminum foil. The composite current collector may include a polymer material base layer and a metallic material layer disposed on at least one surface of the polymer material base layer. The material of the metallic material layer may include at least one selected from the group consisting of aluminum, an aluminum alloy, nickel, a nickel alloy, titanium, a titanium alloy, silver, or a silver alloy. The polymer material base layer may include at least one selected from the group consisting of polypropylene, polyethylene terephthalate, polybutylene terephthalate, polystyrene, or polyethylene. The positive active material layer of this application includes a positive active material. This application has no particular limitation on the type of the positive active material, as long as the purpose of this application can be realized. For example, the positive active material includes at least one selected from the group consisting of lithium cobalt oxide, lithium nickel cobalt manganate (NCM811, NCM622, NCM523, NCM111), lithium nickel manganese aluminate, lithium iron phosphate, lithium vanadium phosphate, lithium cobalt phosphate, lithium manganese phosphate, lithium manganese iron phosphate, lithium iron silicate, lithium vanadium silicate, lithium cobalt silicate, lithium manganese silicate, spinel-type lithium manganate, spinel-type lithium nickel manganate or lithium titanate. This application has no particular limitation on the thicknesses of the positive current collector and the positive active material layer, as long as the purpose of this application can be realized. For example, the thickness of the positive current collector is from 5 μm to 20 μm, and the thickness of the single-sided positive active material layer is from 30 μm to 150 μm. In this application, the positive active material layer may be disposed on a single surface in the thickness direction of the positive current collector, or may be disposed on two surfaces in the thickness direction of the positive current collector. It is hereby noted that the “surface” herein may be the entire area of the positive current collector or a part of an area of the positive current collector, and this application has no particular limitation on as long as the purpose of this application can be realized. The positive active material layer of this application may also include a positive electrode binder. This application has no particular limitation on the type of the positive electrode binder, as long as the purpose of this application can be realized. For example, the type of the positive electrode binder may be the same as the negative electrode binder described above. The positive active material layer of this application may further include a positive electrode conductive agent, and this application has no particular limitation on the conductive agent, as long as the purpose of this application can be realized. For example, the positive electrode conductive agent may be at least one selected from the group consisting of acetylene black, Ketjen black, carbon nanotubes, carbon fibers, carbon quantum dots, or graphene, or the like.

The electrolyte solution of this application may also include a lithium salt and an organic solvent. This application has no particular limitation on the type of the lithium salt, as long as the purpose of this application can be realized. For example, the lithium salt may include, but is not limited to, at least one selected from the group consisting of lithium hexafluorophosphate (LiPF₆), lithium tetrafluoroborate (LiBF₄), lithium difluorophosphate (LiPO₂F₂), lithium bis(trifluoromethanesulphonyl)imide (LiTFSI), lithium bis(fluoro-sulfonyl)imide (LiFSI), lithium bis(oxalato) borate (LiBOB), or lithium difluoro (oxalato) borate (LiDFOB). Based on the mass of the electrolyte solution, the mass percentage of the lithium salt may be from 8% to 15%. For example, the mass percentage of the lithium salt may be 8%, 9%, 10%, 11%, 12.5%, 13%, 15% or a value falling within a range consisting of any two of these values. This application has no particular limitation on the type of the above organic solvent, as long as the purpose of this application can be realized. For example, the organic solvent may include, but is not limited to, at least one of a carbonate compound, a carboxylate compound, an ether compound, or other organic solvents. The above carbonate compound may include, but is not limited to, at least one of a chained carbonate compound or a cyclic carbonate compound. The above chained carbonate compound may include, but is not limited to, at least one of dimethyl carbonate, diethyl carbonate, dipropyl carbonate, methyl propyl carbonate, ethylpropyl carbonate, or methyl ethyl carbonate. The above cyclic carbonate compound may include, but are not limited to, at least one of ethylene carbonate, propylene carbonate (PC), butylidene carbonate, or vinylethylene carbonate. The above carboxylate compound may include, but are not limited to, at least one of methyl formate, methyl acetate, ethyl acetate, n-propyl acetate, tert-butyl acetate, methyl propionate, ethyl propionate, propyl propionate, γ-butyrolactone, decanolactone, pentanolactone, or hexanolactone. The above ether compound may include, but are not limited to, at least one of dimethoxyethane, dibutyl ether, tetraglyme, diethylene glycol dimethyl ether, 1,2-dimethoxyethane, 1,2-diethoxyethane, 1-ethoxy-1-methoxyethane, 2-methyltetrahydrofuran, or tetrahydrofuran. Other organic solvents described above may include, but are not limited to, at least one of dimethyl sulfoxide, cyclopentene oxide, sulfolane, methyl sulfolane, 1,3-dimethyl-2-imidazolidinone, N-methyl-2-pyrrolidinone, dimethylformamide, acetonitrile, trimethyl phosphate, triethyl phosphate, or trioctyl phosphate. Based on the mass the electrolyte solution, the mass percentage of the organic solvent may be from 70% to 87%. For example, the mass percentage of the organic solvent may be 70%, 73%, 75%, 78%, 80%, 82%, 85%, 87%, or a value falling within a range consisting of any two of these values.

The secondary battery of this application further includes a separator for separating the positive electrode plate and the negative electrode plate, preventing an internal short circuit in the secondary battery, allowing electrolyte ions to pass through freely, and not affecting the electrochemical charging and discharging process. This application has no particular limitation on the separator, as long as the purpose of this application can be realized. For example, the material of the separator may include, but is not limited to, polyolefin separators dominated by polyethylene, polypropylene and polytetrafluoroethylene, a polyester film (for example, polyethylene terephthalate (PET) film), a cellulose film, a polyimide film, a polyamide film, a spandex film, an aramid film, or the like. The type of the separator may include, but is not limited to, at least one of a woven film, a non-woven film (non-woven fabric), a microporous film, a composite film, a calendered membrane, a spun film, or the like. The separator of this application may have a porous structure, the porous layer is provided on at least one surface of the separator, and the porous layer includes inorganic particles and a binder. The inorganic particles may include at least one of aluminum oxide, silicon oxide, magnesium oxide, titanium oxide, hafnium oxide, tin oxide, cerium dioxide, nickel oxide, zinc oxide, calcium oxide, zirconium oxide, yttrium oxide, silicon carbide, boehmite, aluminium hydroxide, magnesium hydroxide, calcium hydroxide or barium sulfate. The binder may include at least one of polyvinylidene fluoride, a vinylidene fluoride-hexafluoropropylene copolymer, polyamide, polyacrylonitrile, polymethyl acrylate, polyethylene acrylate, polybutyl polyacrylate, polyacrylic acid, polyacrylate, carboxymethylcellulose sodium, polyvinylpyrrolidone, polyvinyl ether, polymethyl methacrylate, polytetrafluoroethylene or polyhexafluoropropylene. This application has no particular limitation on the size of apertures of the porous structure, as long as the purpose of this application can be realized. For example, the size of the apertures may be from 0.01 μm to 1 μm. This application has no particular limitation on the thickness of the separator, as long as the purpose of this application can be realized. For example, the thickness may be from 3 μm to 30 μm.

The secondary battery of this application further includes a packaging bag for accommodating the positive electrode plate, the separator, the negative electrode plate and the electrolyte solution, as well as other components known in the art in the secondary battery. This application has no particular limitation on the above other components. This application has no particular limitation on the packaging bag, which may be a packaging bag known in the art, as long as the purpose of this application can be realized. For example, an aluminum-plastic film packaging bag may be used.

The secondary battery of this application is not particularly limited and may include any device in which an electrochemical reaction occurs. In one implementation solution of this application, the secondary battery may include, but is not limited to, a lithium-ion battery, a sodium-ion battery, a lithium polymer secondary battery, or a lithium-ion polymer secondary battery, or the like.

The preparation process of the secondary battery of this application is well known to the skilled person in the field, and this application has no particular limitation. For example, the preparation process may include, but is not limited to, the following steps: stacking the positive electrode plate, the separator, and the negative electrode plate in order, winding, folding, and performing other operations as needed to obtain an electrode assembly of a wound structure, placing the electrode assembly into a packaging bag, injecting the electrolyte solution into the packaging bag, sealing the packaging bag, and obtaining the secondary battery; alternatively, stacking the positive electrode plate, the separator, and the negative electrode plate in order, and then fixing four corners of an entire stacked structure with adhesive tape to obtain an electrode assembly of a stacked structure, placing the electrode assembly into a packaging bag, injecting the electrolyte solution into the packaging bag, sealing the packaging bag, and obtaining the secondary battery. In addition, an overcurrent prevention element, a guide plate and the like can also be placed in the packaging bag as needed, thereby preventing pressure rise, overcharging and discharging inside the secondary battery.

A third aspect of this application provides an electronic device, including a secondary battery provided in the second aspect of this application. The secondary battery provided in the second aspect of this application has excellent cycling performance and expansion performance, so that the electronic device of this application has a long service life. This application has no particular limitation on the electronic device, and the electronic device may be any known electronic device used in the prior art. In some embodiments, the electronic device may include, but is not limited to, a laptop computer, a pen-input computer, a mobile computer, an e-book player, a portable telephone, a portable facsimile machine, a portable photocopier, a portable printer, a head-mounted stereo headset, a videocassette recorder, an LCD television, a handheld cleaner, a portable CD player, a minidisc, a transceiver, an electronic organizer, a calculator, a memory card, a portable tape recorder, a radio, a backup power supply, an electric motor, an automobile, a motorcycle, a power-assisted bicycle, a bicycle, a lighting appliance, a toy, a game console, a clock and a watch, an electric tool, a flash lamp, a camera, a large storage battery for household use, a lithium-ion capacitor and the like.

### Embodiment

In the following, implementations of this application are described more specifically by way of embodiments and comparative embodiments. Various tests and evaluations were conducted according to the following methods. In addition, “parts” and “%” are used as mass standards unless otherwise specified.

### Test Method and Apparatus:

### Raman Test:

The Raman spectra of the silicon-based composite material were tested by a laser micro confocal Raman spectrometer (instrument model: HR Evolution, manufacturer: HORIBA, France), the laser wavelength of the Raman spectrometer being 532 nm. Powders of the silicon-based composite material were taken for the test. The test was performed by scanning a range of 100 μm×100 μm and scanning particles within the area. 100 points were tested at equal spacing, and each point was tested in the range of 0.02 cm⁻¹ to 0.05 cm⁻¹. The peak appearing between 1255 cm⁻¹ and 1400 cm⁻¹ was noted as peak D, and the peak appearing between 1550 cm⁻¹ and 1625 cm⁻¹ was noted as peak G. Data processing was carried out to obtain peak intensities of peak D and peak G of the particles, which were noted as I_{D} and I_{G}, respectively. The intensity ratio of I_{D}/I_{G} was counted for each point, and then the average of the 100 points was computed to serve as the final intensity ratio A of I_{D}/I_{G}.

### Infrared Spectrum Testing:

The infrared spectrum of silicon-based composite material was tested by an infrared spectrometer. Test samples were obtained by evenly mixing the silicon-based composite material powder sample and a potassium bromide powder in the mass ratio of 1:100, and grinding and tableting the mixture. The above test samples were placed on a test bench for testing with 32 times of acquisition, a resolution being 4 cm⁻¹, and a light source intensity being 5 W/m2.

### Scanning Electron Microscopy (SEM) Testing:

The morphology of the silicon-based composite material was observed by a Philips XL-30 field emission scanning electron microscope and scanning electron micrographs were taken. The conductive agent and the polymer on the surface of silicon-based composite material were observed using SEM and their dimensional parameters X, Y and Z were obtained by averaging 50 samples counted individually. Examinations were performed at an accelerating voltage of 10 kV and a current of 10 mA.

### Powder Conductivity Test:

A conductivity tester (instrument model: ST-2255A, Suzhou Lattice Electronics) was used to test the powder conductivity of silicon-based composite material. Test samples were obtained by taking 5 g of silicon-based composite material powder samples, using an electronic press to press the samples into sheets, adding pressure to 5000 kg±2 kg and maintaining the pressure for 20 seconds. The test samples were put between the electrodes of the conductivity tester. Through the resistance R ((2) obtained by the voltage U at two ends and the current I, the sample height h (cm), and the area S=3.14 cm² of the powder after tableting, according to the formula of the electronic conductivity 8=h/(S×R), the powder conductivity of the silicon-based composite material is calculated, with a unit of S/cm.

### Powder Particle Diameter Testing:

A Malvern particle sizer (instrument model: Master Sizer 2000) was used to test the particle size distribution of the silicon-based composite material. The sample preparation method is as follows: adding about 0.02 g of a powder sample into a 50 ml clean beaker, adding about 20 ml of deionized water, and then adding 3 drops of sodium dodecyl sulfate as the surfactant, so that the powder was evenly dispersed in the water, and then sonicating for 5 minutes in a 120 W ultrasonic cleaner to obtain a powder particle size test sample. In the volume-based particle size distribution curve of the material, from the small-diameter side, the particle diameter of particles when the cumulative volume percent reaches 50% is Dv50, and the particle diameter of particles when the cumulative volume percent reaches 10% of the cumulative volume is Dv10.

### Cycling Performance Testing:

The lithium-ion battery was placed in a constant temperature oven at 25° C.+1° C. and left to stand for 30 minutes, charged to 4.45 V at a constant current of 0.5 C, then charged to 0.025 C at a constant voltage of 4.45 V, and left to stand for 5 minutes, and then discharged to 3.0 V at 0.5 C, which is a charging and discharging cycle. The first cycle discharge capacity of the lithium-ion battery was recorded as Co. The lithium ion battery was charged and discharged 500 times according to the above charging and discharging cycle. The 500th cycle discharge capacity was recorded as C₁. 500-cycle capacity retention rate=C₁/C₀×100%.

### Expansion Performance Testing:

The lithium-ion battery was charged to 3.95 V at a constant current of 0.5 C, which was the initial half-charged state. The thickness of the lithium-ion battery at the initial half-charged state was measured as H₀ with a spiral micrometer. The above cycling performance test process was cycled for 500 times, and then the lithium-ion battery was charged to 4.45 V at a constant current of 0.5 C, which was the full-charged state. The thickness of the lithium-ion battery at this time was measured as H₁ with the spiral micrometer. 500-cycle expansion rate=(H₁−H₀)/H₀×100%.

### Testing of the Content of Each Component in the Electrolyte Solution:

The lithium-ion battery was disassembled after discharging to 3.0 V at a constant current of 0.5 C. The electrolyte solution was collected, and the disassembled positive electrode plate, negative electrode plate, and separator were centrifuged. The liquid obtained after centrifugation and the above electrolyte solution were mixed evenly, and then tested with gas chromatography-mass spectrometry (instrument model: Agilent 8890) and ion chromatography (instrument model: AQUION Ion Chromatography). Components in the electrolyte solution were obtained and their contents were tested.

### Embodiment 1-1

### <Preparing a Silicon-Based Composite Material>

Step (1): using a silicon-carbon material with a silicon carbon mass ratio of 42:58 as a silicon substrate, and adding a dispersion liquid of the silicon substrate and a single-walled carbon nanotube as a conductive agent (solvent being water, solid content being 0.4%) into deionized water, mixing evenly, stirring for 30 minutes, and then drying at 120° C. to obtain a powder, where, the mass ratio of the silicon substrate to the single-walled carbon nanotube (CNT) as the conductive agent was 100:0.02.

Step (2): evenly mixing the resulting powder and the polymer polyimide (PI, with a weight-average molecular weight of 100,000) in deionized water, stirring for 30 minutes, and then drying at 120° C. to obtain the silicon-based composite material, where, the silicon-based composite material has Dv50 of 9.6 μm and Dv10 of 2.1 μm, and the mass ratio of the silicon substrate to the polymer is 100:5.

### <Preparing a Negative Electrode Plate>

Mixing the silicon-based composite material as the negative active material, artificial graphite, styrene-butadiene rubber (SBR) as the negative electrode binder, and carboxymethyl cellulose (CMC) as the negative electrode dispersant according to a mass ratio of 10:88:1.6:0.4, and then adding deionized water as a solvent and stirring evenly, to prepare a negative electrode slurry with a solid content of 45 wt %. Evenly coating one surface of a negative current collector copper foil with a thickness of 6 μm with the negative electrode slurry, and drying the copper foil at 85° C. for 4 hours to obtain a negative electrode plate with one surface coated with a negative active material layer, where a coating thickness of the negative electrode plate is 80 μm. After cold pressing, slicing, and slitting, drying the negative electrode plate under vacuum at 120° C. for 12 hours to obtain a negative electrode plate with a specification of 76.6 mm×875 mm, where, the cold pressing pressure is 20 tons (t) and the compaction density of the negative electrode plate is 1.78 g/cm³.

### <Preparing a Positive Electrode Plate>

Mixing lithium nickel cobalt manganese (NCM811) as the positive active material, acetylene black as the cathode conductive agent, and polyvinylidene fluoride (PVDF) as the positive electrode binder according to a mass ratio of 96.3:2.2:1.5, and adding N-methyl-pyrrolidone (NMP) as a solvent and stirring evenly, to prepare a positive electrode slurry with a solid content of 75 wt %. Evenly coating one surface of a positive current collector aluminum foil with a thickness of 13 μm with the positive electrode slurry, and drying at 85° C. to obtain a positive active material layer with one surface coated with the positive active material, where a positive active material layer has a thickness of 130 μm. After cold pressing, slicing, and slitting, drying the positive electrode plate under vacuum at 85° C. for 4 hours to obtain a positive electrode plate with a specification of 74 mm×867 mm, where, the cold pressing pressure is 20 t and the compaction density of the positive electrode plate is 4.15 g/cm³.

### <Preparation of an Electrolyte Solution>

In a dry argon atmosphere glove box, mixing ethylene carbonate (EC), propylene carbonate (PC), diethyl carbonate (DEC), and ethyl propionate (EP) which are organic solvents according to a mass ratio of 3:1:3:3, and then adding the lithium salt LiPF₆ and stirring evenly, to prepare the electrolyte solution. Based on the mass of the electrolyte solution, the mass percentage of the lithium salt is 12.5% and the remaining amount is the organic solvents.

### <Separator>

Using a porous polyethylene film (supplied by Celgard) with a thickness of 15 μm as the separator.

### <Preparation of a Lithium-Ion Battery>

Properly and sequentially stacking the positive electrode plate, the separator and the negative electrode plate prepared above, so that the separator is disposed between the positive electrode plate and negative electrode plate to play the role of isolation, and then winding to obtain an electrode assembly. After welding tabs, putting the electrode assembly into an aluminum-plastic film packaging bag, placing in a vacuum oven at 80° C. for 12 hours to remove water, and injecting the electrolyte solution prepared above. Then, performing vacuum packaging, standing, formation (charging to 3.5 V at a constant current of 0.02 C, and then charging to 3.9 V at a constant current of 0.1 C), degassing, and trimming and other procedures, to obtain the lithium-ion battery.

### Embodiment 1-2 to Embodiment 1-15

Identical to Embodiment 1-1 except that the parameters are adjusted according to Table 1.

### Embodiment 2-1 to Embodiment 2-2

Identical to Embodiment 1-1 except that the compaction density of the negative electrode plate is made to be as shown in Table 2 by adjusting the cold pressing pressure.

### Embodiment 3-1 to Embodiment 3-5

Identical to Embodiment 1-1 except that fluoroethylene carbonate (FEC) is further added to the electrolyte solution and the mass percentage C % of fluoroethylene carbonate is adjusted according to Table 3, the mass percentage of the lithium salt is kept unchanged, and the mass percentage of the organic solvent is changed accordingly.

### Embodiment 3-6

Identical to Embodiment 1-10 except that the mass percentage C % of the fluoroethylene carbonate is adjusted according to Table 3, the mass percentage of the lithium salt is kept unchanged, and the mass percentage of the organic solvent is changed accordingly.

### Embodiment 3-7

Identical to Embodiment 1-12 except that the mass percentage C % of the fluoroethylene carbonate is adjusted according to Table 3, the mass percentage of the lithium salt is kept unchanged, and the mass percentage of the organic solvent is changed accordingly.

### Comparative Embodiment 1

Identical to Embodiment 1-1 except that a silicon substrate is used to replace the silicon-based composite material.

### Comparative Embodiment 2

Identical to Embodiment 1-1 except that the silicon-based composite material is prepared through the process <Preparating a silicon-based composite material>.

### <Preparing a Silicon-Based Composite Material>

Using a silicon-carbon material with a silicon carbon mass ratio of 42:58 as a silicon substrate, adding a dispersion liquid of the silicon substrate and a conductive agent CNT into deionized water to mix evenly, stirring for 30 min, and then drying at 120° C. to obtain a powder, where, the mass ratio of the silicon substrate to the conductive agent CNT is 100:0.02.

### Comparative Embodiment 3

Identical to Embodiment 1-1 except that the silicon-based composite material is prepared through the process <Preparating a silicon-based composite material>.

### <Preparing a Silicon-Based Composite Material>

Using a silicon-carbon material with a silicon carbon mass ratio of 42:58 as a silicon substrate, evenly mixing the silicon substrate and the polymer PI (with a weight-average molecular weight of 100,000) in deionized water, stirring for 30 min, and then drying at 120° C. to obtain the silicon-based composite material. The mass ratio of the silicon substrate to the polymer was 100:5.

### Comparative Embodiment 4 to Comparative Embodiment 5

Identical to Embodiment 1-1 except that the parameters are adjusted according to Table 1.

The relevant parameters and performance tests for each embodiment and each comparative embodiment are shown in Tables 1 to 3.

TABLE 1

| | | Mass | | | | | | | |
|---|---|---|---|---|---|---|---|---|---|
| | | ratio | | Mass | | | | | |
| | | of | | ratio | | | | | |
| | | silicon | | of | Step | Step | | | |
| | | substrate | | silicon | (2) | (2) | | | |
| | | to | | substrate | Mixing | Drying | | | |
| | Conductive | conductive | | to | time | temperature | X | Y | |
| | agent | agent | Polymer | polymer | (min) | (° C.) | (nm) | (nm) | X/Y |
| Embodiment | CNT | 100:0.02 | PI | 100:5 | 30 | 120 | 23 | 5 | 4.6 |
| 1-1 | | | | | | | | | |
| Embodiment | CNT | 100:0.02 | PMA | 100:5 | 30 | 120 | 30 | 2.2 | 13.63 |
| 1-2 | | | | | | | | | |
| Embodiment | CNT | 100:0.032 | PI | 100:5 | 30 | 120 | 40 | 2.3 | 17.39 |
| 1-3 | | | | | | | | | |
| Embodiment | CNT | 100:0.004 | PI | 100:5 | 30 | 120 | 34 | 9 | 3.78 |
| 1-4 | | | | | | | | | |
| Embodiment | CNT | 100:0.02 | PI | 100:8 | 30 | 120 | 90 | 3 | 30 |
| 1-5 | | | | | | | | | |
| Embodiment | CNT | 100:0.02 | PI | 100:1 | 30 | 120 | 140 | 2.1 | 66.67 |
| 1-6 | | | | | | | | | |
| Embodiment | CNT | 100:0.032 | PI | 100:8 | 30 | 120 | 29 | 3.1 | 9.35 |
| 1-7 | | | | | | | | | |
| Embodiment | CNT | 100:0.02 | PI | 100:5 | 10 | 120 | 27 | 25 | 1.08 |
| 1-8 | | | | | | | | | |
| Embodiment | CNT | 100:0.02 | PI | 100:5 | 120 | 120 | 40 | 2.3 | 17.39 |
| 1-9 | | | | | | | | | |
| Embodiment | CNT | 100:0.02 | PI | 100:5 | 30 | 200 | 34 | 10 | 3.4 |
| 1-10 | | | | | | | | | |
| Embodiment | CNT | 100:0.02 | PI | 100:5 | 30 | 60 | 90 | 3 | 30 |
| 1-11 | | | | | | | | | |
| Embodiment | CNT | 100:0.02 | PI | 100:0.005 | 30 | 120 | 200 | 0.7 | 285.71 |
| 1-12 | | | | | | | | | |
| Embodiment | CNT | 100:0.02 | PI | 100:5 | 30 | 120 | 10 | 0.5 | 20 |
| 1-13 | | | | | | | | | |
| Embodiment | CNT | 100:0.02 | PI | 100:5 | 30 | 120 | 23 | 20 | 1.15 |
| 1-14 | | | | | | | | | |
| Embodiment | CNT | 100:0.02 | PI | 100:5 | 30 | 120 | 40 | 14 | 2.86 |
| 1-15 | | | | | | | | | |
| Comparative | / | / | / | / | / | / | / | / | / |
| Embodiment | | | | | | | | | |
| 1 | | | | | | | | | |
| Comparative | CNT | 100:0.02 | / | / | 30 | 120 | / | 2 | / |
| Embodiment | | | | | | | | | |
| 2 | | | | | | | | | |
| Comparative | / | / | PI | 100:5 | 30 | 120 | 32 | / | / |
| Embodiment | | | | | | | | | |
| 3 | | | | | | | | | |
| Comparative | CNT | 100:0.08 | PI | 100:5 | 30 | 120 | 28 | 3 | 9.33 |
| Embodiment | | | | | | | | | |
| 4 | | | | | | | | | |
| Comparative | CNT | 100:0.02 | PI | 100:20 | 30 | 120 | 23 | 3.1 | 7.41 |
| Embodiment | | | | | | | | | |
| 5 | | | | | | | | | |

| | | | Location | | | | | | |
|---|---|---|---|---|---|---|---|---|---|
| | | | of | | | | | | |
| | | | stretching | | | | | | |
| | | | vibration | Powder | | | | | |
| | | | peak | conductivity | Dv50 | Dv10 | | | |
| | | | of | of | (μm) | (μm) | Dv50/Dv10 | | |
| | | | carbon- | silicon- | of | of | of | | |
| | | | oxygen | based | silicon- | silicon- | silicon- | Capacity | |
| | | | double | composite | based | based | based | retention | Expansion |
| | Z | | bond | material | composite | composite | composite | rate | rate |
| | (μm) | A | (cm¹) | (S/cm) | material | material | material | (%) | (%) |
| Embodiment | 1 | 0.58 | 1470 | 0.05 | 9.6 | 2.1 | 4.57 | 90.1 | 10 |
| 1-1 | | | | | | | | | |
| Embodiment | 2 | 0.4 | 1442 | 0.06 | 9.7 | 2.2 | 4.4 | 87.9 | 12 |
| 1-2 | | | | | | | | | |
| Embodiment | 1.6 | 0.35 | 1458 | 0.079 | 10.2 | 3.5 | 2.91 | 85.8 | 12.5 |
| 1-3 | | | | | | | | | |
| Embodiment | 2.3 | 0.81 | 1460 | 0.044 | 7.2 | 2.8 | 2.57 | 86.3 | 11.8 |
| 1-4 | | | | | | | | | |
| Embodiment | 3.2 | 0.35 | 1466 | 0.058 | 11 | 2.9 | 3.79 | 88.3 | 11.3 |
| 1-5 | | | | | | | | | |
| Embodiment | 4.2 | 0.9 | 1458 | 0.04 | 5 | 4 | 1.25 | 84.2 | 11.5 |
| 1-6 | | | | | | | | | |
| Embodiment | 2.2 | 0.42 | 1452 | 0.059 | 10.2 | 3.1 | 3.29 | 88.7 | 11.2 |
| 1-7 | | | | | | | | | |
| Embodiment | 2.2 | 0.8 | 1470 | 0.042 | 7 | 2.3 | 3.04 | 88.5 | 11.8 |
| 1-8 | | | | | | | | | |
| Embodiment | 2.5 | 0.4 | 1430 | 0.061 | 11.2 | 1.7 | 6.59 | 85.3 | 11.4 |
| 1-9 | | | | | | | | | |
| Embodiment | 3.6 | 0.2 | 1436 | 0.1 | 11.3 | 2.1 | 5.38 | 84.2 | 11.8 |
| 1-10 | | | | | | | | | |
| Embodiment | 5.4 | 0.8 | 1442 | 0.042 | 8.2 | 2.2 | 3.72 | 88.9 | 11 |
| 1-11 | | | | | | | | | |
| Embodiment | 10.7 | 1.15 | 1452 | 0.04 | 7.5 | 2.1 | 3.57 | 82.1 | 12.9 |
| 1-12 | | | | | | | | | |
| Embodiment | 0.5 | 0.41 | 1449 | 0.081 | 9.8 | 2 | 4.9 | 84.8 | 10.8 |
| 1-13 | | | | | | | | | |
| Embodiment | 8 | 0.52 | 1451 | 0.077 | 9 | 3.1 | 2.9 | 83.1 | 12.5 |
| 1-14 | | | | | | | | | |
| Embodiment | 6 | 0.58 | 1454 | 0.073 | 9.4 | 2.5 | 3.76 | 86.5 | 11.6 |
| 1-15 | | | | | | | | | |
| Comparative | / | 1.2 | / | 0.3 | 7.2 | 0.6 | 12 | 72.1 | 17 |
| Embodiment | | | | | | | | | |
| 1 | | | | | | | | | |
| Comparative | 3.2 | 0.4 | / | 0.35 | 9.2 | 0.8 | 11.5 | 65.2 | 19 |
| Embodiment | | | | | | | | | |
| 2 | | | | | | | | | |
| Comparative | / | 1.2 | 1451 | 0.002 | 10.1 | 0.9 | 11.2 | 65.2 | 18 |
| Embodiment | | | | | | | | | |
| 3 | | | | | | | | | |
| Comparative | 12 | 0.05 | 1451 | 0.9 | 100.2 | 4 | 25.05 | 68.2 | 17.2 |
| Embodiment | | | | | | | | | |
| 4 | | | | | | | | | |
| Comparative | 1 | 1.2 | 1450 | 0.03 | 90.2 | 8 | 11.7 | 58.2 | 8 |
| Embodiment | | | | | | | | | |
| 5 | | | | | | | | | |

Note: “/” in Table I indicates that the substance is not present or the relevant parameter is not available.

As can be seen from Embodiment 1-1 to Embodiment 1-15, and Comparative Embodiment 1 to Comparative Embodiment 5, the negative active material includes the silicon-based composite material of this application. By adjusting the value of A and the powder conductivity of the silicon-based composite material within the ranges of this application, the lithium-ion battery has a higher capacity retention rate and a lower expansion rate, indicating that the lithium-ion battery has better cycling performance and expansion performance.

The value of A usually affects the cycling performance and the expansion performance of the secondary battery. As can be seen from Embodiment 1-1 to Embodiment 1-15, Comparative Embodiment 1, and Comparative Embodiment 4, when A is too large, such as in Comparative Embodiment 1, the capacity retention rate of the lithium-ion battery is lower and the expansion rate of the lithium-ion battery is higher. When A is too small, such as in Comparative Embodiment 4, the capacity retention rate of the lithium-ion battery is lower and the expansion rate of the lithium-ion battery is higher. It indicates that neither too large nor too small the value of A can improve the cycling performance and the expansion performance of the lithium-ion battery. Therefore, by adjusting the value of A within the range of this application, the lithium-ion battery can be made to have a higher capacity retention rate and a lower expansion rate, indicating that the lithium-ion battery has better cycling performance and expansion performance.

The powder conductivity of the silicon-based composite material typically affects the cycling performance and the expansion performance of the secondary battery. As can be seen from Embodiment 1-1 to Embodiment 1-15, Comparative Embodiment 1 to Comparative Embodiment 3, and Comparative Embodiment 5, when the powder conductivity of the silicon-based composite material is too large, such as in Comparative Embodiment 1 and Comparative Embodiment 2, the capacity retention rate of the lithium-ion battery is lower and the expansion rate of the lithium-ion battery is higher. When the powder conductivity of the silicon-based composite material is too small, such as in Comparative Embodiment 3 and Comparative Embodiment 5, the capacity retention rate of the lithium-ion battery is lower and the expansion rate of the lithium-ion battery is higher. It indicates that neither too large nor too the powder conductivity of the silicon-based composite material can improve the cycling performance and the expansion performance of the lithium-ion battery. Therefore, by adjusting the powder conductivity of the silicon-based composite material within the ranges of this application, the lithium-ion battery can be made to have a higher capacity retention rate and a lower expansion rate, indicating that the lithium-ion battery has better cycling performance and expansion performance.

The values of Dv50, Dv10 and Dv50/Dv10 typically affect the cycling performance and the expansion performance of the secondary battery. As can be seen from Embodiment 1-1 to Embodiment 1-15, by adjusting the values of Dv50, Dv10, and Dv50/Dv10 within the ranges of this application, the lithium-ion battery can be made to have a higher capacity retention rate and a lower expansion rate, indicating that the lithium-ion battery has excellent cycling performance and expansion performance.

The values of X, Y, X/Y and Z typically affect the cycling performance and the expansion performance of the secondary battery. As can be seen from Embodiment 1-1 to Embodiment 1-15, by adjusting the values of X, Y, X/Y and Z within the ranges of this application, the lithium-ion battery can be made to have a higher capacity retention rate and a lower expansion rate, indicating that the lithium-ion battery has excellent cycling performance and expansion performance.

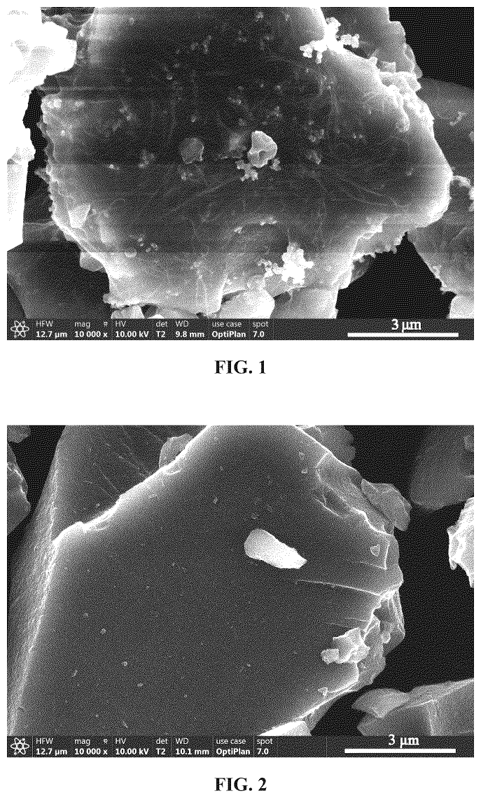

FIG. 1 illustrates a scanning electron microscope photograph of the silicon-based composite material of Embodiment 1-1. As can be seen, the single-walled carbon nanotube as the conductive agent is in the form of threads, and distributed on the surface of the silicon substrate, and the single-walled carbon nanotube is more evenly dispersed on the surface of the silicon substrate; and the polymer is in the form of particles and adhered to the surface of the silicon substrate, and the polymer is more evenly dispersed on the surface of the silicon substrate. FIG. 2 illustrates a scanning electron micrograph of the silicon substrate of Comparative Embodiment 1. As can be seen from FIG. 2, the surface of the silicon substrate is smoother, with smaller fragments of particles of the silicon-carbon material present and no thread-like conductive agent or particulate polymer.

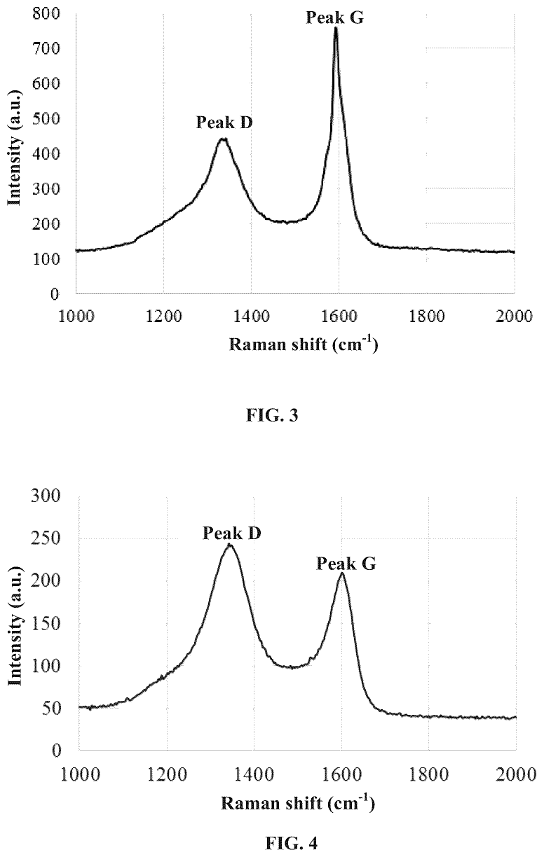

FIG. 3 illustrates the Raman spectrum of the silicon-based composite material of Embodiment 1-1. As can be seen from FIG. 3, the silicon-based composite material of Embodiment 1-1 has an I_{D} value of 442, an I_{G} value of 758, and an A=0.58. FIG. 4 illustrates the Raman spectrum of the silicon substrate of Comparative Embodiment 1. As can be seen from FIG. 4, the silicon substrate of Comparative Embodiment 1 has an In value of 244, an I_{G} value of 205, and an A=1.2.

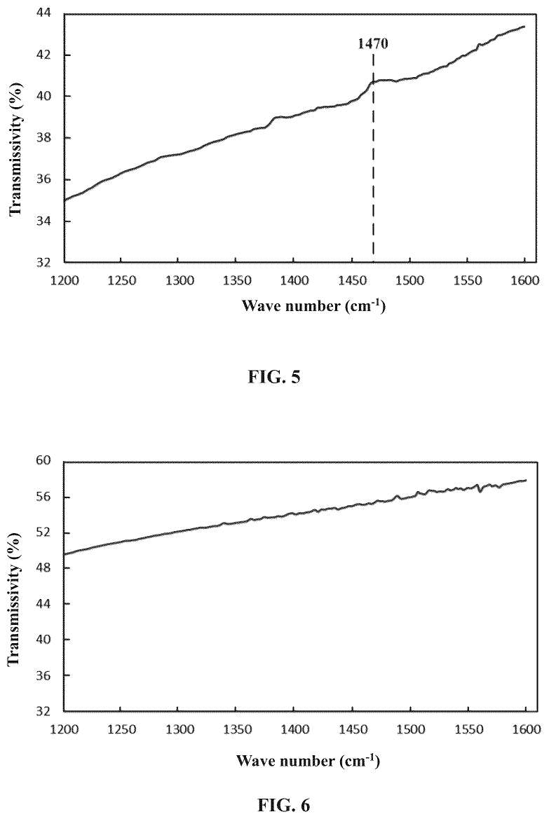

FIG. 5 illustrates an infrared spectrum of the silicon-based composite material of Embodiment 1-1. As can be seen from FIG. 5, the silicon-based composite material of Embodiment 1-1 has a stretching vibration peak of the carbon-oxygen double bond at 1470 cm⁻¹, whereas in an infrared spectrum of the silicon substrate of Comparative Embodiment 1 illustrated in FIG. 6, it can be seen that the silicon substrate of Comparative Embodiment 1 does not have a stretching vibration peak of the carbon-oxygen double bond in the range of 1450+20 cm⁻¹.

TABLE 2

| | Compaction density of | Capacity | |
|---|---|---|---|
| | negative electrode | retention | Expansion |
| | plate (g/cm³) | rate (%) | rate (%) |
| Embodiment 1-1 | 1.78 | 90.1 | 10 |
| Embodiment 2-1 | 0.9 | 88.2 | 9.1 |
| Embodiment 2-2 | 1.9 | 86.2 | 12 |

The compaction density of the negative electrode plate typically affects the cycling performance and the expansion performance of the secondary battery. As can be seen from Embodiment 1-1, and Embodiment 2-1 to Embodiment 2-2, the compaction density of the negative electrode plate is within the range of this application, and the lithium-ion battery has a higher capacity retention rate and a lower expansion rate, indicating that the lithium-ion battery has excellent cycling performance and expansion performance.

TABLE 3

| | | C | | Capacity retention | Expansion |
|---|---|---|---|---|---|
| | A | (%) | A/C | rate (%) | rate (%) |
| Embodiment 1-1 | 0.58 | / | / | 90.1 | 10 |
| Embodiment 3-1 | 0.58 | 5 | 0.12 | 91 | 9.5 |
| Embodiment 3-2 | 0.58 | 10 | 0.06 | 91.6 | 9.2 |
| Embodiment 3-3 | 0.58 | 15 | 0.04 | 92 | 9 |
| Embodiment 3-4 | 0.58 | 3 | 0.2 | 90.2 | 9.8 |
| Embodiment 3-5 | 0.58 | 20 | 0.03 | 90.3 | 9.8 |
| Embodiment 3-6 | 0.2 | 15 | 0.013 | 92.3 | 9.8 |
| Embodiment 3-7 | 1.15 | 5 | 0.23 | 90.8 | 9.9 |

Note: “/” in Table 3 indicates that the substance is not present or the relevant parameter is not available.

The values of A/C and C typically affect the cycling performance and the expansion performance of the secondary battery. As can be seen from Embodiment 1-1, and Embodiment 3-1 to Embodiment 3-7, the electrolyte solution includes fluoroethylene carbonate, and the values of A/C and C are adjusted to be within the ranges of this application, so the lithium-ion battery has a higher capacity retention rate and a lower expansion rate, indicating that the lithium-ion battery has better cycling performance and expansion performance.

It should be noted that the terms “comprising”, “including” or any other variants thereof here are intended to cover non-exclusive inclusions, such that a process, a method or an article including a series of elements not only includes these elements, but also includes other elements that are not listed definitely, or further includes inherent elements for such process, method, or article.

The embodiments of this specification use relevant manners for description. The same or similar parts of the embodiments may refer to each other, and each embodiment highlights the differences from other embodiments.

The above description is only the preferred embodiment of this application and is not be used to limit this application. Any modifications, equivalent replacements, improvements, etc. made within the spirit and principle of this application are to be included within the scope of protection of this application.

What is claimed is:

1. A negative active material, comprising a silicon-based composite material: wherein the silicon-based composite material comprises a silicon substrate, a conductive agent, and a polymer: the conductive agent and the polymer are disposed on at least a portion of a surface of the silicon substrate:
a peak intensity of peak D in a Raman spectrum of the silicon-based composite material with a shift of 1255 cm⁻¹ to 1400 cm⁻¹ is I_{D}, a peak intensity of peak G in the Raman spectrum of the silicon-based composite material with a shift of 1550 cm⁻¹ to 1625 cm⁻¹ is I_{G}, a ratio of I_{D} to I_{G} is A, 0.15≤A≤1.15:
the silicon-based composite material has a stretching vibration peak of a carbon-oxygen double bond at 1450+20 cm⁻¹ in an infrared spectrum; and
a powder conductivity of the silicon-based composite material is from 0.03 S/cm to 0.1 S/cm.

2. The negative active material according to claim 1, wherein Dv50/Dv10 of the silicon-based composite material satisfies 1.25≤Dv50/Dv10≤7, and Dv50 of the silicon-based composite material is from 5 μm to 12 μm.

3. The negative active material according to claim 2, wherein Dv10 of the silicon-based composite material is from 1.7 μm to 4 μm.

4. The negative active material according to claim 1, wherein the negative active material satisfies at least one of following characteristics:
$$0.35 \leq A \leq 0 \text{.85} ; \qquad ( 1 )$$
(2) the powder conductivity of the silicon-based composite material is from 0.04 S/cm to 0.08 S/cm: or
(3) Dv50/Dv10 of the silicon-based composite material satisfies 2≤Dv50/Dv10≤3.5.

5. The negative active material according to claim 1, wherein the conductive agent is in a form of threads, the polymer is in a form of particles, and the negative active material satisfies at least one of following characteristics:
(1) a diameter of a circumscribed circle of particles of the polymer is X nm, and 10≤X≤200:
(2) an average diameter of the conductive agent is Y nm, 0.5≤Y≤20; and an average length of the conductive agent is Z μm, 0.5≤Z≤11; or
(3) a diameter of a circumscribed circle of particles of the polymer is X nm, an average diameter of the conductive agent is Y nm, and 0.5≤X/Y≤400.

6. The negative active material according to claim 1, wherein the conductive agent is in a form of threads, the polymer is in a form of particles, and the negative active material satisfies at least one of following characteristics:
(1) a diameter of a circumscribed circle of particles of the polymer is X nm, and 20≤X≤140;
(2) an average diameter of the conductive agent is Y nm, and 0.5≤Y≤14; an average length of the conductive agent is Z μm, and 1≤Z≤8; or
(3) a diameter of a circumscribed circle of particles of the polymer is X nm, an average diameter of the conductive agent is Y nm, and 0.7≤X/Y≤280.

7. The negative active material according to claim 1, wherein the silicon substrate comprises a silicon element and a carbon element:
the conductive agent comprises a carbon nanotube; and
the polymer comprises at least one selected from the group consisting of polyacrylate, polyimide, polyamide, polyamideimide, polyurethane, sodium carboxymethyl cellulose, potassium carboxymethyl cellulose, sodium hydroxymethyl cellulose or potassium hydroxymethyl cellulose.

8. A secondary battery, comprising a positive electrode plate, a negative electrode plate and an electrolyte solution: wherein the negative electrode plate comprises a negative active material: the negative active material comprises a silicon-based composite material: wherein the silicon-based composite material comprises a silicon substrate, a conductive agent, and a polymer: the conductive agent and the polymer are disposed on at least a portion of a surface of the silicon substrate,
a peak intensity of peak D in a Raman spectrum of the silicon-based composite material with a shift of 1255 cm⁻¹ to 1400 cm⁻¹ is I_{D}, a peak intensity of peak G in the Raman spectrum of the silicon-based composite material with a shift of 1550 cm⁻¹ to 1625 cm⁻¹ is I_{G}, a ratio of I_{D} to I_{G} is A, 0.15≤A≤1.15, the silicon-based composite material has a stretching vibration peak of a carbon-oxygen double bond at 1450+20 cm⁻¹ in an infrared spectrum; and
a powder conductivity of the silicon-based composite material is from 0.03 S/cm to 0.1 S/cm.

9. The secondary battery according to claim 8, wherein the negative electrode plate has a compaction density from 0.9 g/cm³ to 1.9 g/cm³.

10. The secondary battery according to claim 8, wherein the electrolyte solution comprises fluoroethylene carbonate: based on a mass of the electrolyte solution, a mass percentage of the fluoroethylene carbonate is C %, 5≤C≤15, and 0.01≤A/C≤0.23.

11. The secondary battery according to claim 8, wherein 0.35≤A≤0.85.

12. The secondary battery according to claim 8, wherein Dv50/Dv10 of the silicon-based composite material satisfies 1.25≤Dv50/Dv10≤7, and Dv50 of the silicon-based composite material is from 5 μm to 12 μm.

13. The secondary battery according to claim 12, wherein 2≤Dv50/Dv10≤3.5.

14. The secondary battery according to claim 8, wherein the conductive agent is in a form of threads, and the polymer is in a form of particles.

15. The secondary battery according to claim 14, wherein a diameter of a circumscribed circle of particles of the polymer is X nm, and 10≤X≤200.

16. The secondary battery according to claim 14, wherein an average diameter of the conductive agent is Y nm, 0.5≤Y≤20; and
an average length of the conductive agent is Z μm, 0.5≤Z≤11.

17. The secondary battery according to claim 16, wherein 0.5≤Y≤14 and 1≤Z≤8.

18. The secondary battery according to claim 15, wherein an average diameter of the conductive agent is Y nm, 0.5≤X/Y≤400.

19. The secondary battery according to claim 18, wherein 0.7≤X/Y≤280.

20. The secondary battery according to claim 14, wherein the silicon substrate comprises a silicon element and a carbon element;
the conductive agent comprises a carbon nanotube; and
the polymer comprises at least one selected from the group consisting of polyacrylate, polyimide, polyamide, polyamideimide, polyurethane, sodium carboxymethyl cellulose, potassium carboxymethyl cellulose, sodium hydroxymethyl cellulose or potassium hydroxymethyl cellulose.
